(19) United States
(12) Patent Application Publication
(10) Pub. No.: US 2007/0204889 A1
(43) Pub. Date: Sep. 6, 2007

(54) Articulable arm for a mobile mark removal system

(76) Inventor: James P. Crocker, Stuart, FL (US)

Correspondence Address: MCHALE & SLAVIN, P.A., 2855 PGA BLVD, PALM BEACH GARDENS, FL, 33410, US

(21) Appl. No.: 11/368,020

(22) Filed: Mar. 3, 2006

(51) Int. Cl. B08B 3/12; B08B 3/00

(52) U.S. Cl. 134/172; 134/198; 239/722

(57) ABSTRACT

Briefly, disclosed is an articulable arm particularly suited for mobile systems utilized to remove coatings from marked surfaces with high pressure liquid. The mobile systems generally employ a liquid reservoir connected to a high pressure pump for directing ultra high pressure water through at least one blast head mounted on a front portion of a mobile self-propelled vehicle. A vacuum reservoir and vacuum pump may be utilized to recover the water and debris from the surface. The arm permits an operator to easily maintain alignment of the blast heads to the surface markings being removed. After marking removal the arm permits the blast heads to be raised to position suitable for inspection and/or vehicle transport.

### RELATED APPLICATIONS

This application is related to U.S. patent application Ser. No. 10/884,643, filed Jul. 2, 2004 and entitled “Stripe Removal System”, U.S. patent application Ser. No. 11/340,738 filed Jan. 5, 2006 and entitled “Transportable Holding Tank for Stripe Removal Systems” U.S. patent application Ser. No. 11/340,104 filed Jan. 26, 2006 and entitled “Mobile Mark Removal System” U.S. patent application entitled “Combined Grinder and Waterblaster for Stripe Removal System” filed Mar. 3, 2006 U.S. Express Mail number EV531127416US, the contents of which are incorporated herein in F their entirety.

### FIELD OF THE INVENTION

This invention relates to the field of high pressure water cleaning devices for highways, runways, parking decks, factory floors and other marked surfaces.

### PRIOR ART BACKGROUND

The use of paint stripes on road surfaces is the accepted method to indicate vehicle lanes, crossing lanes, parking areas and numerous other indicators. Various pavement marking techniques are well known in the art, including the use of traffic paint, thermoplastics, epoxy paints and preformed tapes. Most pavement marking systems are intended to be as durable and permanent as possible, and resistant to weathering and wear from traffic. Common road surfaces are asphalt and concrete. The removal of such striping is typically required when the road is to be resurfaced or if the indication is to be changed.

When polymers such as paint or plastic are used for roadway marking, the surface of the pavement is penetrated from ⅛-⅜inch, so that mere surface removal of the marking material is not sufficient to remove the marking. Therefore, current pavement marking removal machines often employ various forms of cutting devices to remove the marking material, as well as a portion of the underlying layer of pavement material in order to effectively remove painted lines.

Commonly known methods for removal of such markings typically include the use of abrasive grinding wheels, material removing cutters, or blasting of abrasive particles against the material to be removed. However, the use of these devices often results in undesirable grooves in the pavement surface.

For example, one type of cutting machine is disclosed in U.S. Pat. No. 5,236,278, known as a “Road Pro” and is manufactured by Dickson Industries, Inc. This type of machine employs parallel passive shafts that extend between circular rotating end plates. Hardened steel star wheels are carried on the parallel passive shafts, and these star wheels strike and abrade the pavement surface. While this type of device is effective for removal of markings, it often creates excessive heat which may melt thermoplastic materials and cause equipment to gum up.

Another approach to pavement marking removal is the use of diamond saw blades or cutters arranged to make a dado cut. Still other types of machines use grinders or shot blast as described in U.S. Pat. Nos. 4,753,052; 4,376,358; 3,900,969; 4,336,671; 3,977,128 and 4,377,924. Unfortunately, these devices must remove a portion of the pavement material to effectively remove the marking, thereby leaving unsightly and potentially dangerous grooves in the pavement.

It is also known in the art to utilize high-pressure water jets to remove markings from pavement. NLB Corporation markets a high pressure water jet system for removing paint from pavement under the name “STARJET”. The STARJET system includes a blast head frame mounted on an attachment to the front bumper of a prime-mover truck. Casters support the frame for movement over the pavement and the path of the blast head is controlled by the driver steering the truck. Because of the position of the driver and the cab body of the prime-mover, it is difficult for the operator to see the blast head's position with regard to the stripes on the pavement. Obtaining clear vision requires the driver to lean out of the driver's side window, resulting in fatigue and other non-ergonomically efficient factors. Positioning the blast head to the passenger side of the prime mover is performed manually with some difficulty complicating the driver's ability to view the path of the blast head. In addition, due to the length of the extension holding the blast head, the angular off-set, and the swivel of the casters, the movement of the wheel of the truck is not directly related to the path of the blast head further complicating operation.

NLB Corporation also has another system marketed under the name “STRIPEJET”, that is a self-propelled tractor with a blast head mounted on the front of the tractor. A problem associated with the STRIPEJET device relates to the construction of the blast head mounting assembly. The mounting assembly includes a rigid track mounted transversely across the front of the tractor. A hydraulic cylinder is utilized to slide the blast head transversely across the rigid track to position the blast head. The construction limits visibility of the blast head to the operator. In addition, the construction prohibits the blast head from being positioned beyond the sides of the tractor. Still yet, the NLB construction only permits the blast head to be raised eighteen inches above the ground surface. This does not permit the operator to inspect the rotating assembly and/or nozzles of the blast assembly without exiting the vehicle and laying on the ground to look up into the blast head assembly.

Therefore, what is needed in the art is an articulating arm for a marking removal system. The articulating arm should permit movement of a blast head about a plurality of axes. The plurality of axis should permit the blast head to be easily aligned with the mark(s) to be removed from inside the vehicle. The arm should permit the blast head(s) to be positioned beyond the width of the vehicle to allow operation from a single road lane. The arm should articulate to a position that allows the inspection of the blast head from inside of the vehicle. The arm should facilitate mounting of multiple blast heads upon a single arm. Articulation of the arm should permit the blast heads to be oriented side by side, spaced along parallel paths, and one behind the other for increased efficiency in marking removal.

### SUMMARY OF THE PRESENT INVENTION

Briefly, disclosed is an articulable arm particularly suited for mobile systems utilized to remove markings and/or coatings from surfaces with high pressure liquid. The mobile systems generally employ a liquid reservoir connected to a high pressure pump for directing ultra high pressure water through a blast head mounted on a front portion of the vehicle. A vacuum reservoir and vacuum pump are utilized to recover the water and debris from the surface. The arm permits an operator to easily maintain alignment of the blast heads to the surface markings being removed. After marking removal, the arm permits the blast heads to be raised to a position suitable for vehicle transport.

The base of the articulable arm is preferably mounted at about the center of the front portion of the truck. The articulable arm includes a primary extension assembly and a secondary extension assembly connected with a first transitional link assembly, at the distal end of the secondary extension assembly is a second transitional link assembly. Each component of the arm is independently positionable by an operator from within the vehicle. Mounted to the second transitional link assembly is one or more, preferably two, blast heads; the two blast heads positioned in a spaced apart arrangement along an axis that extends perpendicular to the longitudinal axis of the secondary extension assembly. This construction permits an operator to position each blast head over a separate surface marking, e.g. stripe or the like, to remove the two markings simultaneously. Rotation of the secondary extension assembly allows the operator to position the blast heads along juxtapositioned paths for creating a single, wide cleaning path. Alternatively, the secondary extension assembly may be rotated to position the blast heads one behind the other for dual cleaning of a single path.

In addition to allowing the blast heads to be raised for transport, the secondary extension assembly facilitates raising the blast head(s) to a position which allows the operator to inspect the water blast head assembly from within the cab of the truck.

Therefore, it is an objective of this invention to provide an articulable arm for surface marking removal systems.

It is another objective of the instant invention to provide an articulable arm that includes a water blast head for marking removal.

It is a further objective of the instant invention to provide an articulable arm that includes two water blast heads to allow multiple configurations of marking removal.

It is yet a further objective of the instant invention to provide an articulable arm that includes a primary extension assembly and a secondary extension assembly, each of which is independently controllable by an operator.

It is still another objective of the instant invention to provide an articulable arm having sufficient length to extend beyond the sides of the vehicle to which it is attached.

Still yet another objective of the instant invention is to provide an articulable arm which facilitates raising the blast head(s) to a position suitable to allow an operator to inspect the blast head(s) from within the vehicle.

Other objectives and advantages of this invention will become apparent from the following description taken in conjunction with the accompanying drawings wherein are set forth, by way of illustration and example, certain embodiments of this invention. The drawings constitute a part of this specification and include exemplary embodiments of the present invention and illustrate various objects and features thereof.

### BRIEF DESCRIPTION OF THE DRAWINGS

While the novel features of the invention are set forth with particularity in the appended claims, the invention, both as to organization and content, will be better understood and appreciated from the following detailed description, taken in conjunction with the drawings, in which:

FIG. 1 is a perspective view of one embodiment of the instant invention illustrated with a single blast head in an operating position;

FIG. 2 is an exploded perspective view illustrating one embodiment of the articulable arm of the instant invention;

FIG. 3 is a side view illustrating one embodiment of the instant invention;

FIG. 4 is a top view illustrating one embodiment of the instant invention;

FIG. 5 is a perspective view of one embodiment of the instant invention illustrated without the actuators for clarity;

FIG. 6 is a perspective view of one embodiment of the instant invention illustrated without the actuators for clarity;

FIG. 7 is a top view of one embodiment of the instant invention illustrating the blast heads positioned in a spaced parallel relationship;

FIG. 8 is a top view of one embodiment of the instant invention illustrating the blast heads positioned for juxtaposed cleaning paths;

FIG. 9 is a top view of one embodiment of the instant invention illustrating the blast heads positioned for overlapping coverage of the marked surface;

FIG. 10 is a perspective view illustrating a blast head suitable for use with the instant invention.

### DETAILED DESCRIPTION OF THE INVENTION

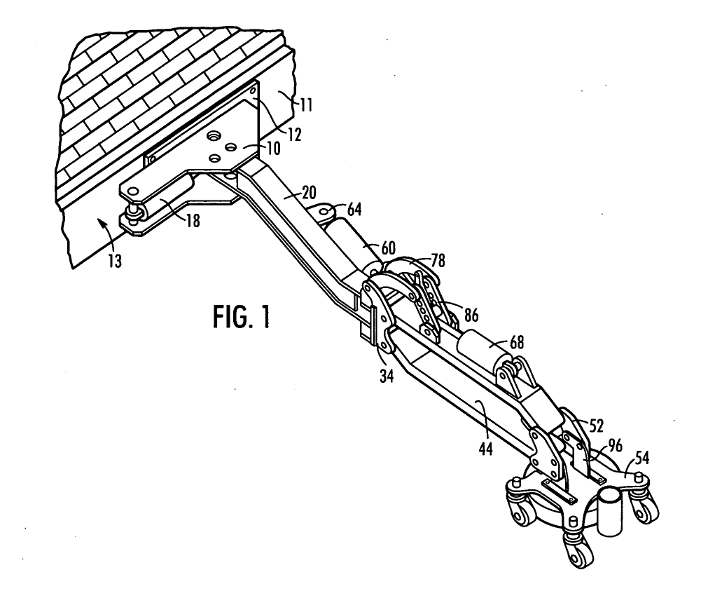

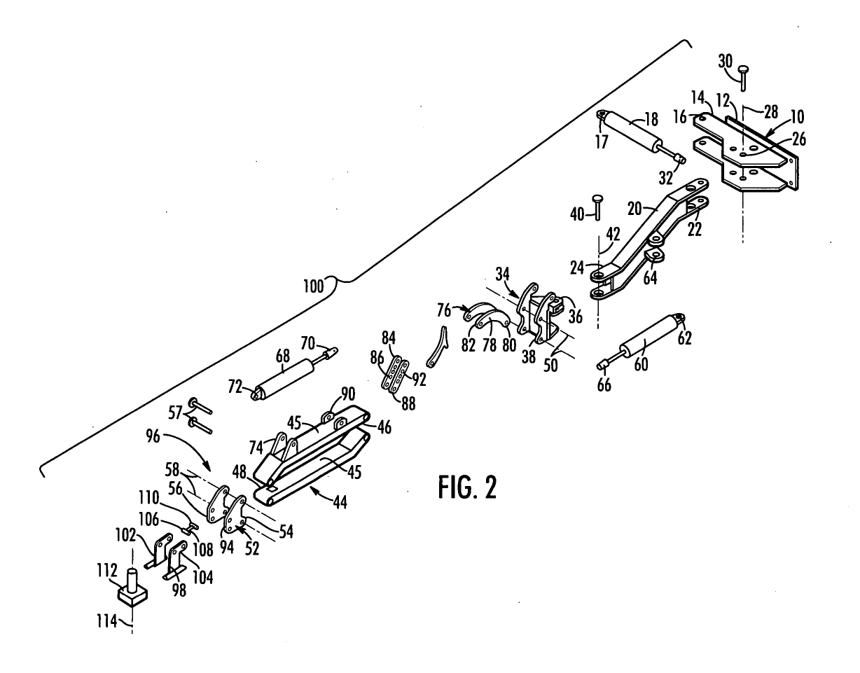

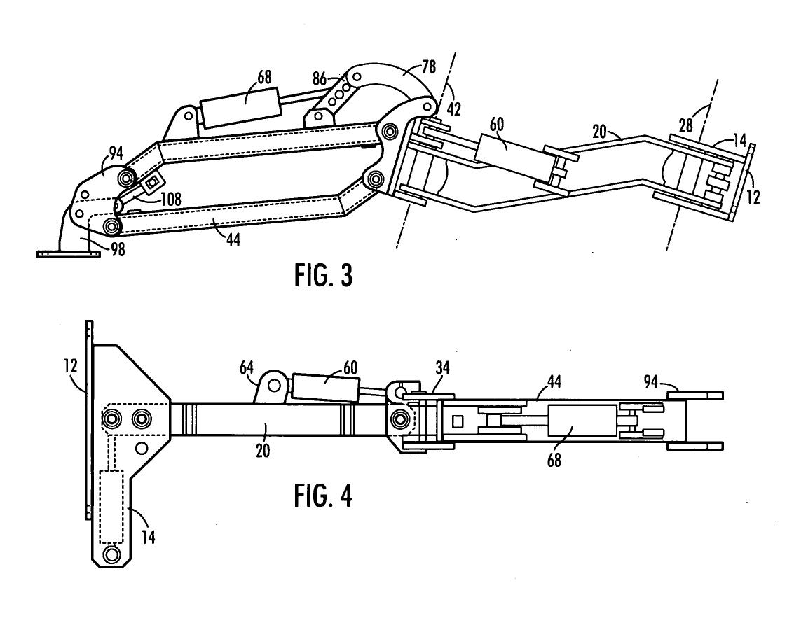

Referring generally to FIGS. 1-10, an articulable arm 100 for use in removing markings from a marked surface is illustrated. The articulable arm is constructed and arranged to be infinitely positioned relative to the front portion 11 of a mobile vehicle 13 in a manner that allows the arm to extend beyond the sides of the vehicle if desired. A joystick or other suitable control device (not shown) is provided in the mobile vehicle to allow an operator to manipulate the articulable arm about the various axes for an operator determined path.

The articulable arm includes a base member 10 securable to a mobile marking removal vehicle. The mobile marking removal vehicle is preferably a truck, as illustrated in FIG. 1. However, tractors, heavy equipment and the like may be utilized without departing from the scope of the invention. In a most preferred embodiment, the base anchor plate 12 is secured to a central location on a front portion of the vehicle for easy viewing of the assembly by an operator. At least two stanchions 14 are suitably secured to the base plate at about a perpendicular angle thereto. The stanchions are provided with an aperture 16 or other suitable means for securement of a first end 17 of a primary extension assembly actuator 18. The stanchions are also provided with apertures 26 that define a first axis of rotation 28.

A primary extension assembly 20 includes a first end 22 and a second end 24. The first end of the primary extension assembly is pivotally secured to the stanchions 14 of the base member 10 via pin 30 for controlled movement about the first axis 28. A primary actuator 18 having a first end 17 secured to the base member 10 and a second end 32 secured to the first end 22 of the primary extension assembly provides infinitely positionable controlled rotatation of the primary extension assembly throughout a curved horizontal path.

A first transitional link assembly 34 includes a first end 36 and a second end 38, the first end being pivotally secured to the second end 24 of the primary extension assembly via pin 40 for controlled horizontal movement about second axis 42. A secondary extension assembly actuator 60 having a first end 62 secured to the primary extension assembly 20 via stanchions 64, and a second end 66 secured to the first end 36 of the first transitional link assembly 34 provides controlled rotational movement of the secondary extension assembly 44 about second axis 42. In this manner, selective operation of the secondary actuator provides infinitely positionable control of the second end 48 of the secondary extension assembly 44 throughout a curved horizontal path. The first transitional link assembly 34 includes a toggle link assembly 76, the toggle link assembly includes a pair of arctuate members 78 each having a first end 80 pivotally connected to the first transitional link assembly 34 and a second end 82 pivotally connected to a first end 84 of a substantially straight member 86. A second end 88 of the straight member 86 is pivotally connected to tabs 90 secured to the secondary extension assembly 44. In a most preferred embodiment, the straight member includes a plurality of apertures 92 therethrough for pivotal connection to the first end 70 of said third actuator 68.

A secondary extension assembly 44 includes a pair of arms 45, each having a first end 46 and a second end 48. The first end of each arm is pivotally secured to the second end 38 of the transitional link assembly 34 for controlled vertical movement about a pair of parallel third axes 50 so that the arms 45 remain substantially parallel when moved through a vertical path. A third actuator 68 having a first end 70 secured to the second end 38 of the first transitional link assembly 34 and a second end 72 secured to the secondary extension assembly tabs 74 provides controlled rotation of the secondary extension assembly 44 about the third axes 50. In this manner, selective operation of the third actuator 68 provides infinitely positionable control of the second end 48 of the secondary extension assembly 44 throughout a curved vertical path.

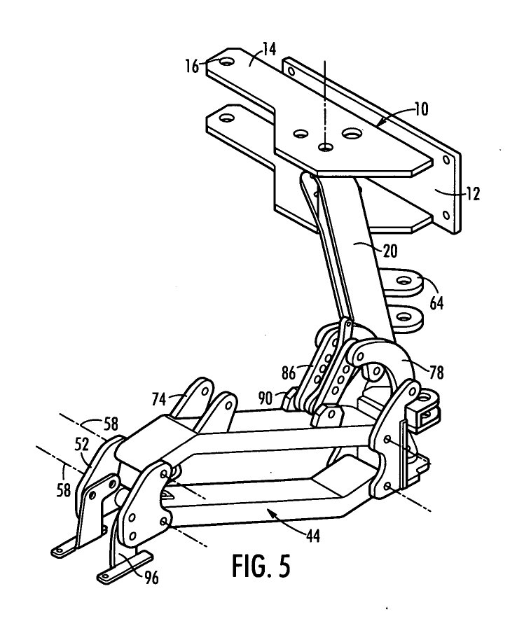

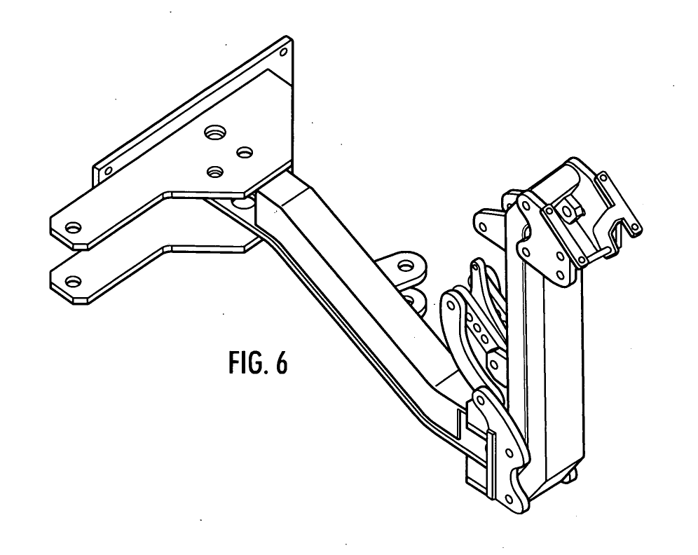

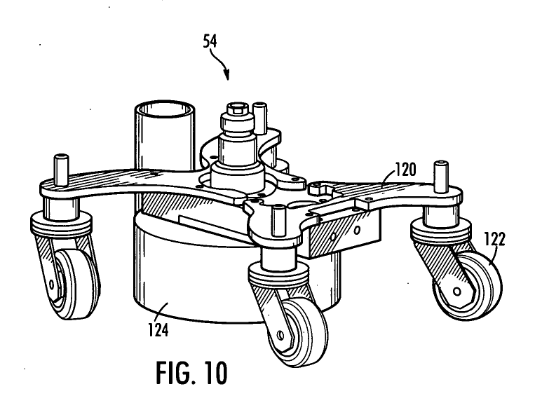

A second transitional link assembly 52 includes a first end 54 and a second end 56. The first end 54 is pivotally secured to the second end 48 of the secondary extension assembly via pins 57 for controlled movement about a pair of fourth axes 58. The second end 56 of the second transitional link assembly 52 is secured to at least one blast head assembly 54 (FIG. 10). The second transitional link assembly 52 includes two mounting plates 94 secured in a substantially parallel arrangement with respect to each other and said second axis 42. In this manner, the mounting plates 94 remain substantially parallel to the second axis irrespective of the position of said primary extension assembly 20 and/or the secondary extension assembly 44. Thus the blasting heads 54 may be secured directly to the mounting plates for maintaining parallel alignment to the ground surface regardless of the position of the arms, as illustrated in Fig.5. Alternatively, a pivot assembly 96 may be utilized to automatically rotate the blast head(s) 54 to a position that allows an underside of the blast head(s) to be viewed from an operator position when the secondary extension assembly 44 is raised to an uppermost position, as shown in FIG. 6. The pivot assembly includes a pair of generally L-shaped brackets 98, one pivotally secured to each of the mounting plates 94. Each of the L-shaped brackets includes a generally vertical first leg 102 and a generally horizontal second leg 104. The first legs include a tie rod 106 having a first end 108 pivotally secured thereto, a second end 110 being pivotally secured to the secondary extension assembly 44. The second leg of the L-shaped brackets are constructed and arranged for securing at least one and preferably two blast heads thereto. In this manner, vertical movement of the secondary extension assembly 44 to an uppermost position causes rotation of the L-shaped brackets, as shown in FIG. 6, to a position that allows an underside of the blast head(s) to be viewed from an operator position.

The second transitional link assembly may also include a means for rotating two blast heads about a sixth axis 114 extending substantially perpendicular with respect to the fourth axes 58. The meas for rotating the blast heads about a sixth axis is illustrated herein as a rotation assembly 112. The rotation assembly preferably utilizes an actuator to provide operator controlled rotation however, cables belts or suitable combinations thereof may be utilized without departing from the scope of the invention. In this manner, the two blast heads may be oriented side by side, spaced along parallel paths, or one behind the other for marking removal.

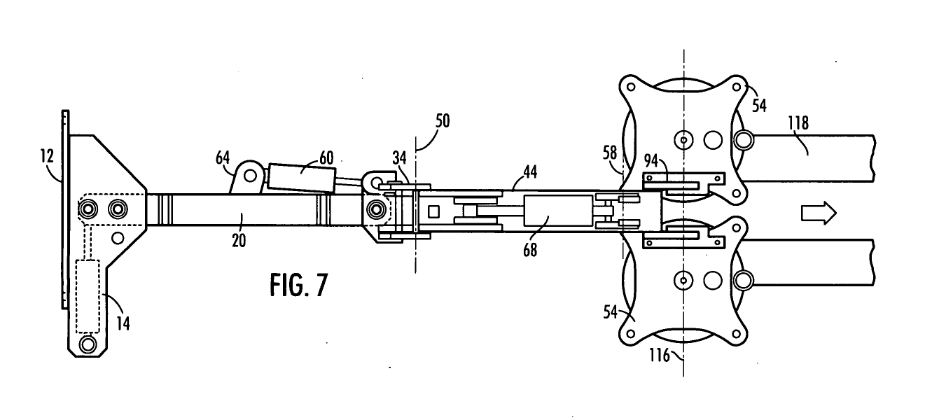

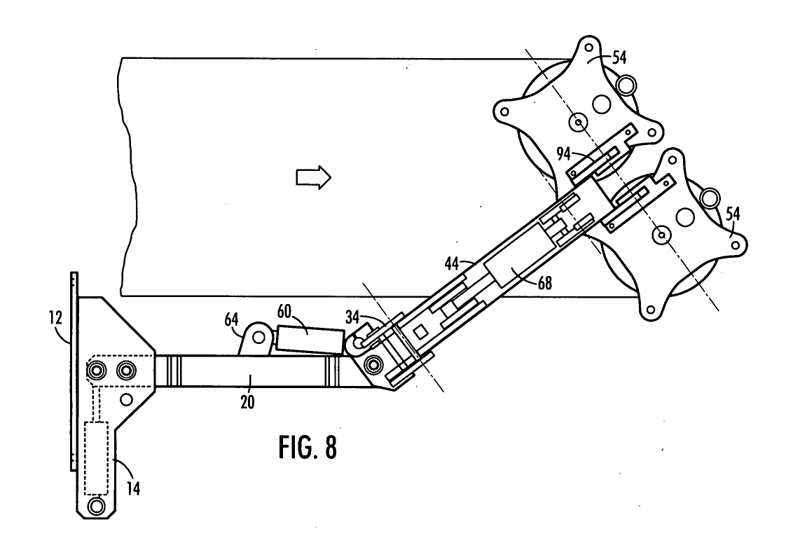

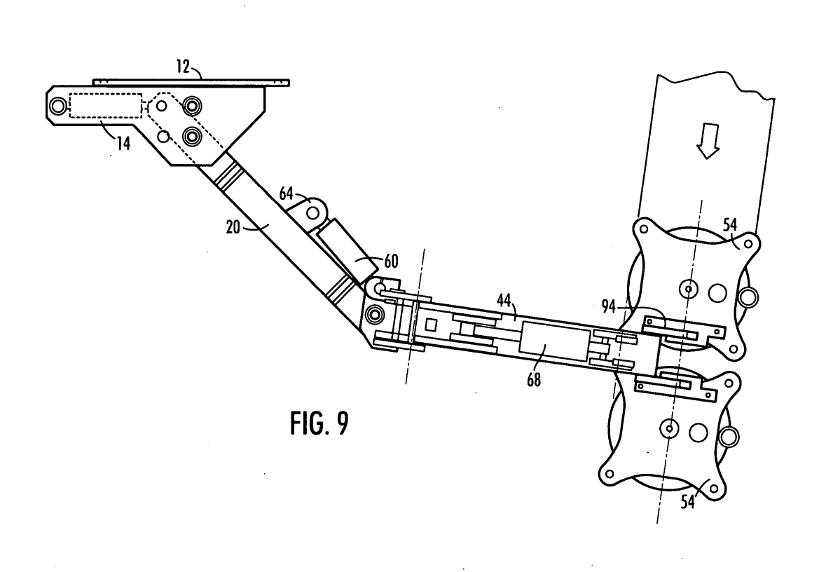

Referring to FIGS. 7-9, the two blast heads 54 are spaced apart and positioned along a fifth axis 116 extending substantially parallel with respect to said fourth axes 58. This configuration of the articulable arm is especially useful for marking removal. The positioning of the blast heads at the distal end of the articulable arm allows the blast head positioning and orientation to be controlled for optimum marking removal. For example, selective positioning of the secondary extension assembly 44 allows the two blast heads 54 to be positioned over two spaced surface markings 118 for simultaneous removal. In addition, selective positioning of the secondary extension assembly 44 also allows the two blast heads 54 to be positioned for juxtaposed cleaning paths, as illustrated in FIG. 8. Still yet, selective positioning of the secondary extension assembly 44 allows the two blast heads 54 to be positioned one behind the other for overlapping coverage of the marked surface, as illustrated in FIG. 9.

Referring to FIG. 10, a blast head 54 suitable for use with the instant invention is illustrated. The blast head is carried on a chassis 120 supported on casters 122. A shroud 124 descends from the chassis and surrounds a rotating spray head (not shown) that includes a plurality of high pressure nozzles. The spray head is connected to a high pressure fluid pump (not shown) by suitable means such as a high pressure hose. The shroud 124 is connected to a vacuum tank (not shown) by suitable means such as a vacuum hose (not shown).

It should be noted that while the preferred embodiment of the instant invention utilizes hydraulic actuators for controlled movement of the various components pneumatics, servos, electric motors or suitable combinations thereof may be utilized without departing from the scope of the invention.

All patents and publications mentioned in this specification are indicative of the levels of those skilled in the art to which the invention pertains. All patents and publications are herein incorporated by reference to the same extent as if each individual publication was specifically and individually indicated to be incorporated by reference.

It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to, what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. An articulable arm for use in removing markings from a marked surface comprising:
a base member secured to a mobile marking removal vehicle;
a primary extension assembly having a first end and a second end, said first end pivotally secured to said base member for controlled movement about a first axis;
a first transitional link assembly having a first end and a second end, said first end pivotally secured to said second end of said primary extension assembly for controlled horizontal movement about a second axis;
a secondary extension assembly having a first end and a second end, said first end pivotally secured to said second end of said transitional link assembly for controlled vertical movement about a third axis;
a second transitional link assembly having a first end and a second end, said first end pivotally secured to said second end of said secondary extension assembly for controlled movement about a fourth axes, said second end of said wrist secured to at least one blast head assembly;
whereby said articulable arm provides controlled movement about said first, second, third and fourth axes for positioning of said blast head assembly for removing markings from a marked surface.

2. The articulable arm of claim 1 wherein said mobile marking vehicle is a truck.

3. The articulable arm of claim 1 wherein said mobile marking vehicle is a tractor.

4. The articulable arm of claim 1 wherein said blast head assembly is a water-blast head, wherein said at least one blast head includes at least one nozzle constructed and arranged to expel ultra-high pressure liquid, whereby said articulable arm is manipulable to maintain said at least one nozzle at a controlled standoff distance from an upper surface of said roadway.

5. The articulable arm of claim 1 including a primary actuator having a first end secured to said base member and a second end secured to said first end of said primary extension assembly for rotating said primary extension assembly about said first axis, whereby selective operation of said primary actuator provides infinitely positionable control of said second end of said primary extension assembly throughout a curved horizontal path.

6. The articulable arm of claim 1 including a secondary extension assembly actuator having a first end secured to said primary extension assembly and a second end secured to said first end of said first transitional link assembly for rotating said secondary extension assembly about said second axis, whereby selective operation of said secondary actuator provides infinitely positionable control of said second end of said secondary extension assembly throughout a curved horizontal path.

7. The articulable arm of claim 1 including a third actuator having a first end secured to said second end of said first transitional link assembly and a second end secured to said secondary extension assembly for rotating said secondary extension assembly about said third axis, whereby selective operation of said third actuator provides infinitely positionable control of said second end of said secondary extension assembly throughout a curved vertical path.

8. The articulable arm of claim 7 wherein said secondary extension assembly includes a pair of arms, wherein one of said pair of arms is secured between one of a pair of third axes and one of a pair of fourth axes so that said arms remain substantially parallel when moved through said vertical path.

9. An articulable arm for use in removing markings from a roadway surface comprising:
a base member securable to a mobile marking removal vehicle;
a primary extension assembly having a first end and a second end, said first end pivotally secured to said base member for controlled movement about a first axis;
a first transitional link assembly having a first end and a second end, said first end pivotally secured to said second end of said primary extension assembly for controlled horizontal movement about a second axis;
a secondary extension assembly having a first end and a second end, said first end pivotally secured to said second end of said transitional link assembly for controlled vertical movement about a third axis;
a second transitional link assembly having a first end and a second end, said first end pivotally secured to said second end of said secondary extension assembly for controlled movement about a fourth axes, said second end of said second transitional link assembly secured to at least one blast head assembly;
whereby said articulable arm provides controlled movement about said first, second, third and fourth axes for positioning of said blast head assembly for removing markings from a marked surface.

10. The articulable arm of claim 9 wherein said blast head assembly is a water-blast head, wherein said at least one blast head includes at least one nozzle constructed and arranged to expel ultra-high pressure liquid, whereby said articulable arm is manipulable to maintain said at least one nozzle at a controlled standoff distance from an upper surface of said marked surface.

11. The articulable arm of claim 9 including a primary actuator having a first end secured to said base member and a second end secured to said first end of said primary extension assembly for rotating said primary extension assembly about said first axis;
whereby selective operation of said primary actuator provides infinitely positionable control of said second end of said primary extension assembly throughout a curved horizontal path.

12. The articulable arm of claim 9 including a secondary extension assembly actuator having a first end secured to said primary extension assembly and a second end secured to said first end of said first transitional link assembly for rotating said secondary extension assembly about said second axis, whereby selective operation of said secondary actuator provides infinitely positionable control of said second end of said secondary extension assembly throughout a curved horizontal path.

13. The articulable arm of claim 9 including a third actuator having a first end secured to said second end of said first transitional link assembly and a second end secured to said secondary extension assembly for rotating said secondary extension assembly about said third axis, whereby selective operation of said third actuator provides infinitely positionable control of said second end of said secondary extension assembly throughout a curved vertical path.

14. The articulable arm of claim 13 wherein said secondary extension assembly includes a pair arms, wherein one of said pair of arms is secured between one of a pair of third axes and one of a pair of fourth axes so that said arms remain substantially parallel when moved through said vertical path.

15. The articulable arm of claim 13 wherein said first transitional link assembly includes a toggle link assembly, said toggle link assembly including an arctuate member having a first end pivotally connected to said first transitional link assembly and a second end pivotally connected to a first end of a substantially straight member, a second end of said straight member pivotally connected to said secondary extension assembly, wherein said straight member includes a plurality of apertures therethrough for pivotal connection to said first end of said third actuator.

16. The articulable arm of claim 13 wherein said second transitional link assembly includes at least one mounting plate for securing said blast head so that said blast head remains parallel to a ground surface irrespective of the position of said primary extension assembly or said secondary extension assembly.

17. The articulable arm of claim 16 wherein said second transitional link assembly includes two mounting plates secured in a substantially parallel arrangement with respect to each other and said second axis;
whereby said mounting plates remain substantially parallel to said second axis irrespective of the position of said primary extension assembly and said secondary extension assembly.

18. The articulable arm of claim 13 wherein said second transitional link assembly includes a first pivot assembly, whereby said pivot assembly is constructed and arranged to automatically rotate said blast head to a position that allows an underside of said blast head to be viewed from an operator position when said secondary extension assembly is raised to an uppermost position.

19. The articulable arm of claim 17 wherein said first pivot assembly includes a pair of L-shaped brackets one pivotally secured to each of said mounting plates, each of said L-shaped brackets including a generally vertical first leg and a generally horizontal second leg, said first legs including a tie rod having a first end pivotally secured thereto, a second end of said tie rod being pivotally secured to said secondary extension assembly, said second leg having at least one blast head secured thereto, whereby vertical movement of said secondary extension assembly to an uppermost position causes rotation of said L-shaped brackets rotating said at least one blast head to a position that allows an underside of said at least one blast head to be viewed from an operator position.

20. The articulable arm of claim 10 wherein said at least one blast head assembly includes a rotating spray head therein, said rotating spray head including a plurality of nozzles for discharging ultra-high pressure water to impinge against said roadway surface.

21. The articulable arm of claim 19 wherein said second transitional link includes two blast heads secured thereto.

22. The articulable arm of claim 21 wherein said two blast heads are spaced apart and positioned along a fifth axis extending substantially parallel with respect to said fourth axes, whereby selective positioning of said secondary extension assembly allows said two blast heads to be positioned over two spaced roadway markings for simultaneous removal, whereby selective positioning of said secondary extension assembly allows said two blast heads to be positioned for juxtaposed cleaning paths, whereby selective positioning of said secondary extension assembly allows said two blast heads to be positioned one behind the other for overlapping coverage of said marked surface.

23. The articulable arm of claim 17 wherein said second transitional link assembly includes a means for rotating two blast heads about a sixth axis extending substantially perpendicular with respect to said fourth axes, whereby operator controlled rotation of said means for rotating allows said two blast heads to be oriented side by side, spaced along parallel paths, or one behind the other for marking removal.

24. The articulable arm of claim 23 wherein said means for rotating is selected from the group consisting of cables, belts, and rotary actuators.
